(19) United States
(12) Patent Application Publication
(10) Pub. No.: US 2012/0191388 A1
(43) Pub. Date: Jul. 26, 2012

(54) DIAGNOSTIC METHOD TO CHECK FOR STUCK BITS IN STORAGE REGISTERS OF SAFETY-CRITICAL SYSTEMS

(75) Inventor: Robert Parle, Oxford (GB)

(73) Assignee: ANALOG DEVICES, INC., Norwood, MA (US)

(21) Appl. No.: 13/182,884

(22) Filed: Jul. 14, 2011

Related U.S. Application Data
(60) Provisional application No. 61/436,067, filed on Jan. 25, 2011.

(51) Int. Cl. G06F 19/00; G06F 11/267

(52) U.S. Cl. 702/63; 714/726; 714/E11.162

(57) ABSTRACT

Method to verify proper operation of battery monitor shift register(s). The method may be implemented on an individual battery monitor or within a system of battery monitors. Battery monitor shift register(s) may be configured to store predetermined test patterns upon start up or reset. The contents of the battery monitor shift registers may be shifted out serially to a processor or controller, which may compare the read out data to a local copy of the predetermined test pattern. If the patterns do not match, the processor or controller may indicate an error condition.

### RELATED APPLICATION

This application claims the benefit of priority afforded by U.S. provisional patent application Ser. No. 61/436,067 filed on Jan. 25, 2011. This application relates to co-pending application “Diagnostic Method to Monitor Battery Cells of Safety-Critical Systems,” reference number 13641-431801, also filed on May 20, 2011.

### BACKGROUND

Shift registers are devices that store data values and may be configured to store data values that vary in bit-length. Data values may be written into or read from a shift register. Data may be written to or read from a shift register in bit word format. Although shift registers provide an efficient mechanism for storing data values, their electrical characteristics may make them susceptible to circuit malfunctions due to processing errors or damage to the circuit. These hardware operating malfunctions may cause data values at a particular bit position within a shift register to be held or “stuck” to an erroneous value rather than writing new data to that bit position. Because data is read from a shift register in a serial manner, a stuck bit at a particular bit position may corrupt each data bit that may be shifted through that particular bit position. Accordingly, there is a need in the art for a diagnostic method to verify that shift registers are operating properly without stuck bits.

### BRIEF DESCRIPTION OF THE DRAWINGS

FIGS. 1-2 illustrate block diagrams of battery monitoring systems according to an embodiment of the present invention.

FIG. 3 illustrates an exemplary register shifting operation performed on shift registers of a plurality of battery monitors according to an embodiment of the present invention.

FIG. 4 illustrates a method to check for stuck bits within a battery monitor shift register according to an embodiment of the present invention.

FIGS. 5-6 illustrate exemplary error scenarios involving stuck bits that can arise in battery monitor shift registers.

FIGS. 7-9 illustrate exemplary implementations for loading test patterns into shift registers according to an embodiment of the present invention.

FIG. 10 illustrates a block diagram of an exemplary shift register according to an embodiment of the present invention.

### DETAILED DESCRIPTION

Embodiments of the present invention provide techniques to verify proper operation of battery monitor shift register(s). The method may be implemented on an individual battery monitor or within a system of battery monitors. According to such embodiments, battery monitor shift register(s) may be configured to store predetermined test patterns upon start up or reset. The contents of the battery monitor shift registers may be shifted out serially to a processor or controller, which may compare the read-out data to a local copy of the predetermined test pattern. If the patterns do not match, the processor or controller may indicate an error condition.

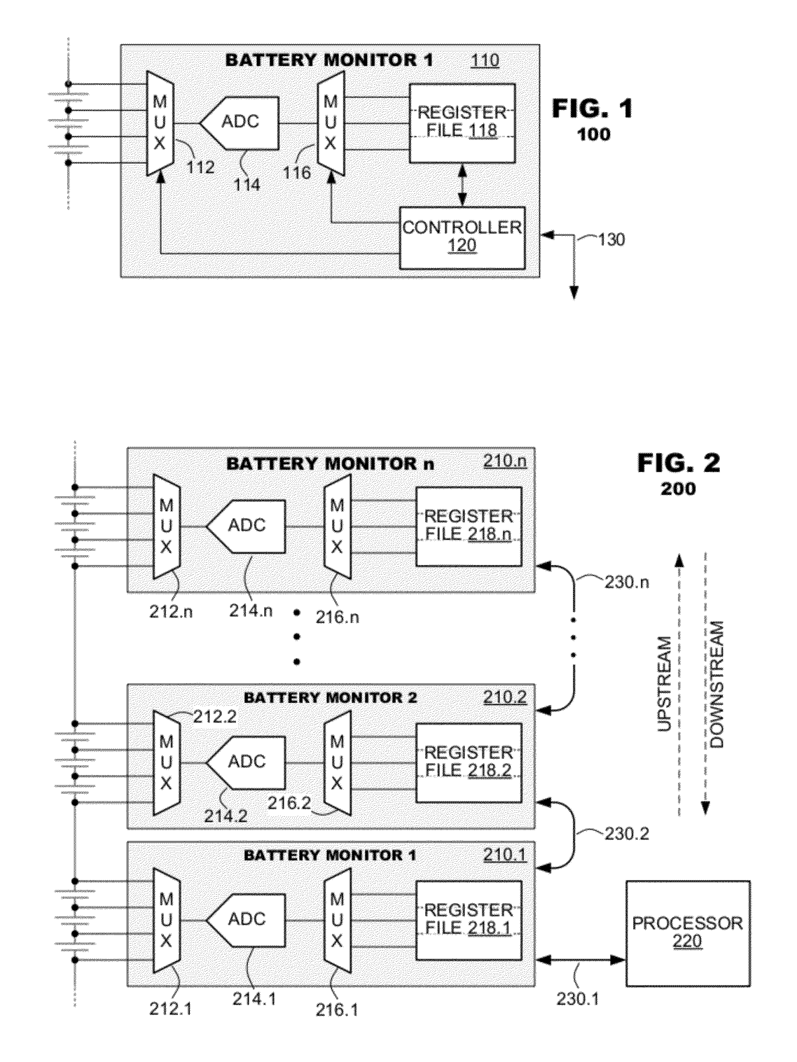

FIG. 1 illustrates a block diagram of a battery monitoring system 100 according to an embodiment of the present invention. A battery monitor 110 may have inputs coupled to respective cells of a battery or a battery system. The battery monitor 110 may include a first and second multiplexer (MUX) 112,116, an analog-to-digital converter (ADC) 114, a register file 118, and a controller 120. The first MUX 112 may have inputs coupled to the battery cells, a control input coupled to the controller 120, and an output for a signal representing battery cell voltages. The ADC 114 may have an input coupled to the first MUX 112 output and an output for a signal representing digital samples of battery cell voltages. The second MUX 116 may have an input coupled to the ADC 114 output, a control input coupled to the controller 120, and outputs for signals representing digital samples of battery cell voltages. The register file 118 may have inputs coupled to the second MUX 116 outputs and may store digital samples of battery cell voltages in internal registers. As noted, the controller 120 may be coupled to the register file 118 as well as the first and second MUX 112, 116. The controller 120 may output respective control signals to each device.

The battery monitor 110 may be configured to accept inputs from a predetermined number of battery cells. For example, the configuration illustrated in FIG. 1 shows a battery monitor 110 with four inputs which provides capability to monitor three different battery cells. In this regard, the battery monitor 110 is considered to be a three channel device. The register file 118 may have a number of registers that correspond to the number of channels supported by the battery monitor 110 (e.g., three registers for a three channel device). Other implementations may be provided having a different number of channels than illustrated here.

During operation, the first MUX 112 may activate a pair of inputs associated with a battery cell (a battery “channel”) being processed. Voltages from the inputs may be routed to the ADC 114. The ADC 114 may sample a voltage across the battery cell and may convert it to a digital value representing the sampled voltage. The digital value may have a predetermined bit width, for example, 14 bits. The ADC 114 may output the digital value to a register associated with the channel being sampled via the second MUX 116. The battery monitor 110 may sample and digitize voltages of each of the battery channels in turn and store digital values for each channel in the register file 118. The controller 120 may control: reset operations for the battery monitor 110, the channel select order for the first and second MUX 112, 116, and the read and write order for the register file 118. The controller 120 may read the stored digital values for each channel from the register file 118. The digital values may further be communicated to a processor (not shown) via a serial communication port 130 for further processing.

FIG. 2 illustrates a block diagram of a battery monitoring system 200 according to an embodiment of the present invention. The monitoring system 200 may include a plurality of monitoring units 210.1-210.n and a processor 220. The monitoring units 210.1-210.n may have inputs coupled to respective cells of a battery system. The processor 220 may be coupled to the monitoring units 210.1-210.n via communication links 230.1-230.n. The monitoring units (ex., unit 210.1) may include a first MUX 212.1 having inputs coupled to the battery cells, an ADC 214.1 coupled to an output of the respective first MUX 212.1, a second MUX 216.1 coupled to an output of the ADC 214.1, and a register file 218.1 coupled to outputs of the respective second MUX 216.1 for storage of digital data output by the ADC 214.1.

Each battery monitor 210.1-210.n may be configured to accept inputs from a predetermined number of battery cells. For example, the configuration illustrated in FIG. 2 shows battery monitors with four inputs which provide capability to monitor three different battery cells. In this regard, the battery monitors 210.1-210.n may be considered to be three channel devices. The register file 218.1 may have a number of registers that correspond to the number of channels supported by the monitoring unit 210.1 (e.g., three registers for a three channel device). Other implementations may be provided having a different number of channels than illustrated here.

During operation, the first MUX 212.1 may activate a pair of inputs associated with a battery channel being processed. Voltages from the inputs may be routed to the ADC 214.1. The ADC 214.1 may sample a voltage across the battery cell and may convert it to a digital value representing the sampled voltage. The digital value may have a predetermined bit width, for example, 14 bits. The ADC 214.1 may output the digital value to a register associated with the channel being sampled. The battery monitor 210.1 may sample and digitize voltages of each of the battery channels in turn and store digital values for each channel in the register file 218.1. Each battery monitor 210.1-210.n may operate in this manner.

As noted, the processor 220 may be connected to the battery monitors 210.1-210.n by a variety of communication links. In the configuration illustrated in FIG. 2, the communication links may be provisioned as a plurality of serial busses 230.1-230.n, each a single bit wide. The communication links 230.1-230.n may operate in “daisy chain” fashion in which the processor 220 is directly connected to a first battery monitor 210.1 by a first serial link 230.1. The first battery monitor 210.1 is connected to a second battery monitor 210.2 via a second serial link 230.2. Battery monitors at intermediate positions within the daisy chain may be connected to a downstream battery monitor by one serial link and to an upstream battery monitor by a second serial link. The final battery monitor 210.n is connected to a prior battery monitor by a final serial link 230.n.

The serial links may define a communication flow in two directions, an upstream direction in which processor commands may be relayed from the processor 220 to the first battery monitor 210.1 and relayed among the battery monitors until they reach the last battery monitor in the chain 210.n, and a downstream direction in which any battery monitor (say, monitor 210.2) may transmit a message and convey it to an adjacent battery monitor (monitor 210.1) in the direction of the processor. Intermediate battery monitors may relay the message down the daisy chain until a final battery monitor (monitor 210.1) delivers the message to the processor.

In this regard, the battery monitors 210.1-210.n may include transceiver circuitry to manage communication flow across the communication links 230.1-230.n, not shown in FIG. 2. Further description of the battery monitors and transceiver circuitry may be found in U.S. Publication No. 2008/0183914 and No. 2010/0277231, which is incorporated by reference herein.

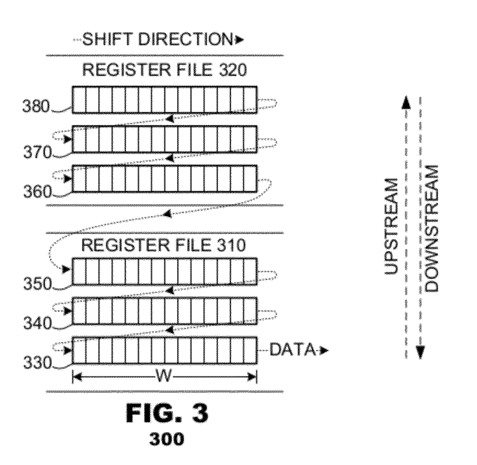

FIG. 3 illustrates a schematic diagram 300 describing an exemplary register shifting operation performed on digital battery data between a pair of battery monitors according to an embodiment of the present invention. Here, each battery monitor may be illustrated as having a register file having three registers, each of bit width W. Registers 330-350 may be shown as included in a first battery monitor register file 310 and registers 360-380 may be shown as included in a second battery monitor register file 320.

During ADC operation, the registers may be loaded with digital data representing the digital voltages of associated battery cells. To read data out of the registers to the processor, the registers 330-380 may operate as a cascaded set of shift registers. The shifting operation 300 may shift data in direction that proceeds across the illustrated registers in a downstream direction. According to the shifting operation 300, data of all the registers may be shifted on each occurrence of a driving clock (not shown). Each shift cycle may cause a shift by a single bit position. A single bit of data may be shifted in bitwise order within a register (say, register 380) and, when it may reach the end of the register 380, it may shifted to a next register in order, for example, register 370. When a bit of data reaches a last bit position in a last register 360 of an intermediate register file (e.g., register file 218.2 within battery monitor 210.2 of FIG. 2), it may be shifted to a first bit position of a first register 350 in a next battery monitor 310 via a respective communication link. When a bit of data reaches a last bit position in the last register 330 of the last battery monitor (e.g., battery monitor 210.1 of FIG. 2), it may be shifted to a controller or to a processor via a respective communication link.

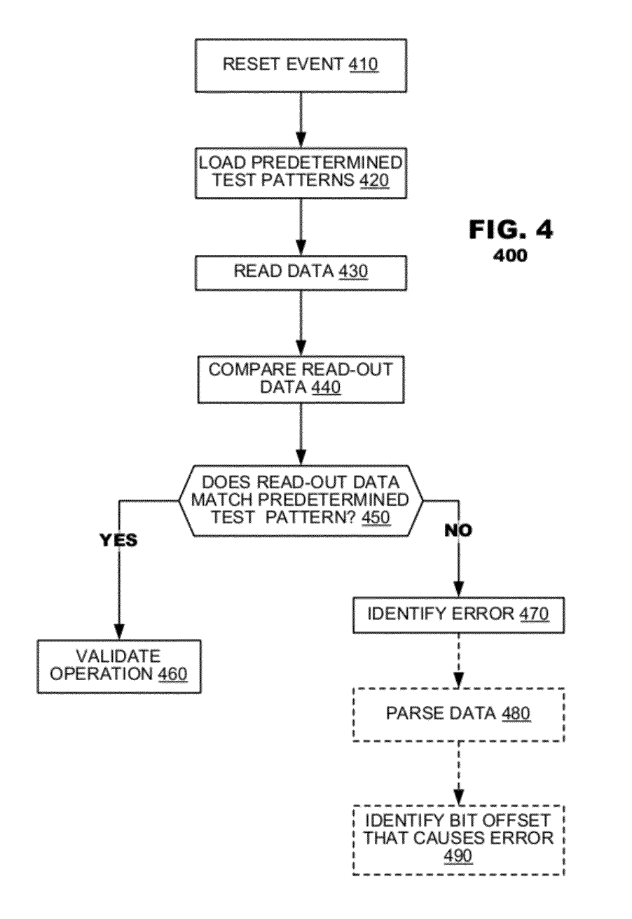

FIG. 4 illustrates a method 400 to check for stuck bits within a battery monitor shift register according to an embodiment of the present invention. As illustrated in block 410, a reset event may initialize the battery monitor. In response, predetermined test patterns may be loaded into the battery monitor shift registers (block 420). After loading the shift registers, data may be read back out from the shift registers (block 430). The read-out data may be compared to a local copy of the predetermined test patterns (block 440). If the read-out data matches the local copy of the predetermined test patterns (block 450), the method 400 may validate the battery monitor as passing the stuck bits check (block 460). If not, the method 400 may identify an error within the battery monitor (block 470). In another embodiment, the method 400 may parse the read-out data from each register into a data word corresponding to the bit-length of the registers in the register file (block 480). After parsing the data, the method 400 may identify the word that caused the error and correlate that word to a particular shift register that may be malfunctioning (block 490). According to an embodiment of the present invention, the method 400 may be performed by a processor or controller.

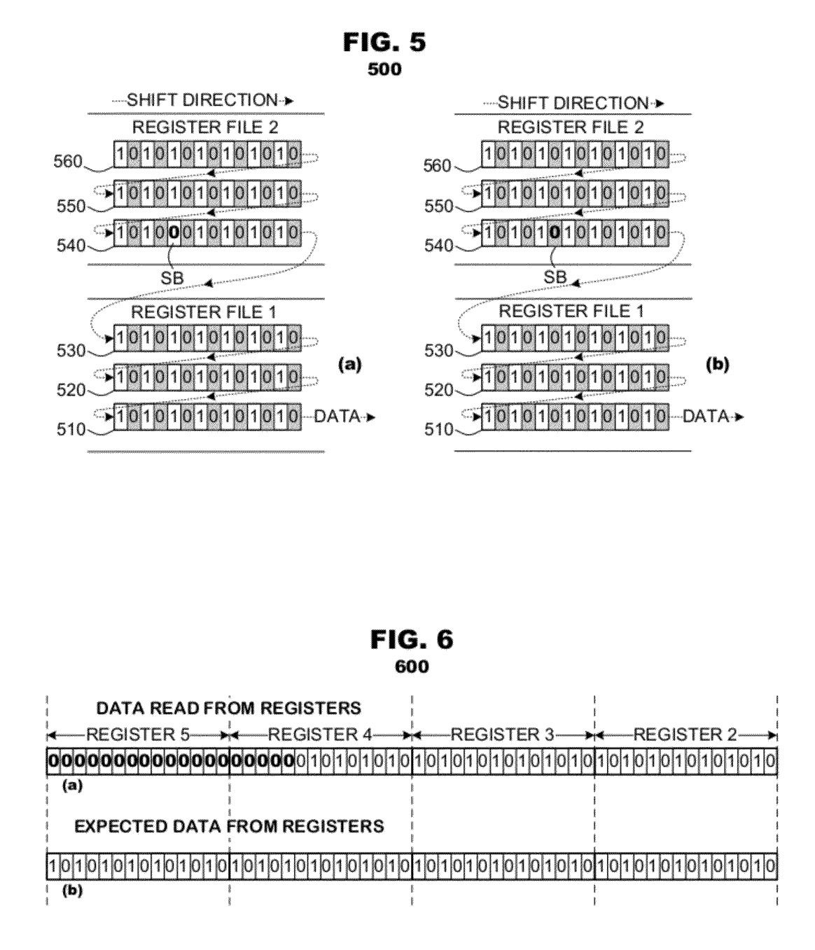

FIG. 5 illustrates two exemplary error scenarios 500 involving stuck bits that may arise between a pair of battery monitor shift registers within a battery monitor system. Here, each battery monitor may be illustrated as having a register file having three registers. As illustrated in FIG. 5(a), a stuck bit SB may occur in register 540 in the tenth position from the right. In FIG. 5(b), a stuck bit SB may occur in register 540 the ninth position from the right.

FIG. 6 illustrates test patterns 600 that may arise when shifting data across the stuck bit as illustrated in FIG. 5. During operation of the diagnostic method, data may be shifted to a processor or controller in order first from register 510, second from register 520, and last from register 560. For any bit position among the registers that may be downstream of the stuck bit position SB (e.g., registers 510-530 and lower order bit positions of register 540), a processor or controller may detect a match between its local test pattern and the data pattern read from the registers. For any bit position among the registers that may be upstream of the stuck bit position SB (e.g., the higher order bit positions of register 540 and registers 550-560), a processor or controller may detect a mismatch between its local test pattern and the data pattern read from the registers. In this manner, a processor or controller may detect the location of the most downstream stuck bit.

In the example of FIG. 5(a), the stuck bit error causes bit position SB to be stuck at a “0” value. As data may be shifted into the SB position, the data may be erased and replaced with a 0 value. Thus, all upstream data may be driven to a 0 value before being read out. A similar phenomenon may occur if a bit position were stuck at a “1” value. All data upstream of the stuck bit position may be driven to a 1 value before being read out. FIG. 5(a) illustrates a scenario in which a bit position, which may be reset to a 1 value, may be stuck at a 0 value due a circuit malfunction. FIG. 5(b) illustrates another error scenario in which a bit position should take a value of 0 at reset but, due to circuit malfunction, cannot transition to a 1 value during readout. These two error scenarios may give rise to the same erroneous output data pattern shown in FIG. 6(a) while the expected output data pattern is illustrated in FIG. 6(b).

In an embodiment, a processor or controller within a battery monitor system may parse input data read from the battery monitors into words corresponding to the length of the registers of the monitors (block 480 of FIG. 4). FIG. 3 illustrates an exemplary register word length W of 14 bits. When an error may be detected, the processor or controller may identify the battery monitor or shift register that possesses the stuck bit error by identifying the word in which the mismatch first occurred between the input data and the locally generated reference pattern. Having identified the battery monitor or shift register where the stuck bit error likely is present, the processor or controller may generate an alert that identifies the battery monitor or shift register that may be associated with the register error. Typically, the processor or controller may store the identifier of the battery monitor or shift register in a non-volatile memory of an associated diagnostic system.

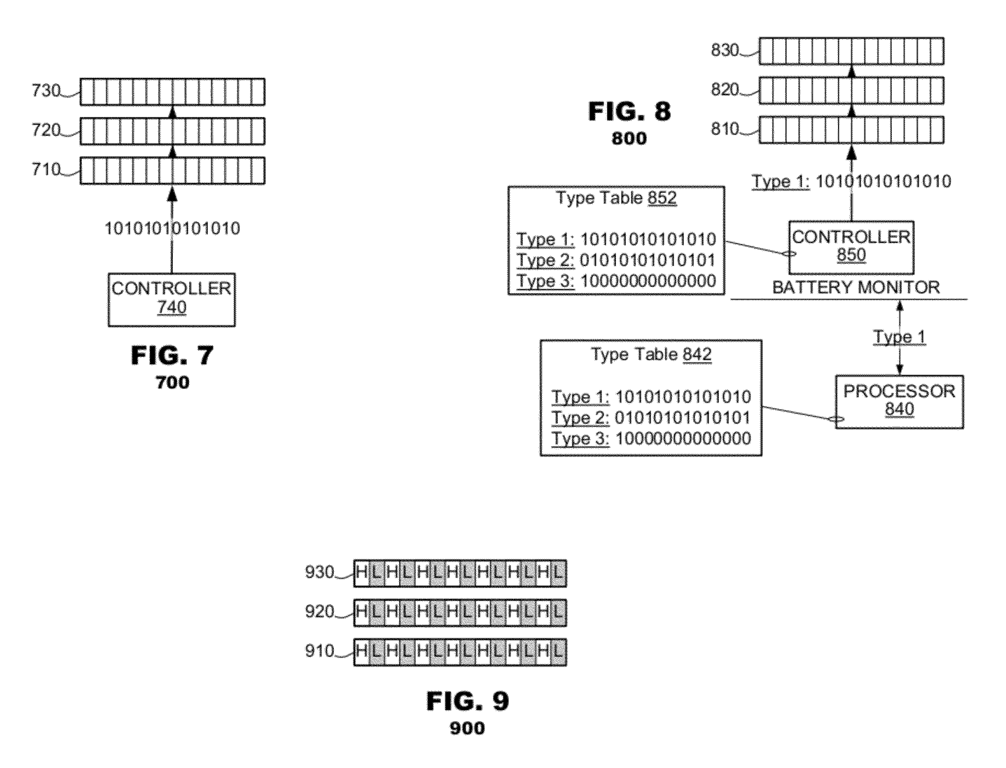

FIG. 7 illustrates an exemplary implementation 700 for loading a test pattern into shift registers according to an embodiment of the present invention. As illustrated, a predetermined test pattern may be loaded into the shift registers 710-730 by a controller 740 in the event of reset.

FIG. 8 illustrates another exemplary implementation 800 for loading a test pattern into shift registers according to an embodiment of the present invention. As illustrated, a predetermined test pattern type may be loaded into the shift registers 810-830 by a controller 850. A type table 842 may be stored in a processor 840 and a corresponding type table copy 852 may be stored in the controller 850. The processor 840 may communicate a predetermined test pattern type for the controller 850 to load into the shift registers 810-830. For example, both the processor and controller type tables 842, 852 may contain three possible predetermined test pattern types 1-3. The types may correspond to predetermined patterns of 1s and 0s. Upon receiving a reset signal (not shown), the processor 840 may communicate to the controller 850 to load type 1 into the shift registers 810-830. In response, the controller 850 may load the predetermined test pattern corresponding to type 1 from the type table 852 to the shift registers 810-830.

FIG. 9 illustrates yet another exemplary implementation 900 for loading a test pattern into shift registers according to an embodiment of the present invention. As illustrated, registers 910-930 may be comprised of a plurality of single bit storage cells of reset high type H and reset low type L. The reset high type and reset low type may be distributed according to the predetermined test pattern. Storage cells H that may be reset to digital values of “1” may be provisioned as reset high cells, which may be initialized to a 1 value in response to a reset signal (not shown). Storage cells L that may be reset to values of “0” may be provisioned as reset low cells, which may be initialized to a 0 value in response to the reset signal. Thus, the reset signal may cause the registers themselves to initialize with the reset test pattern.

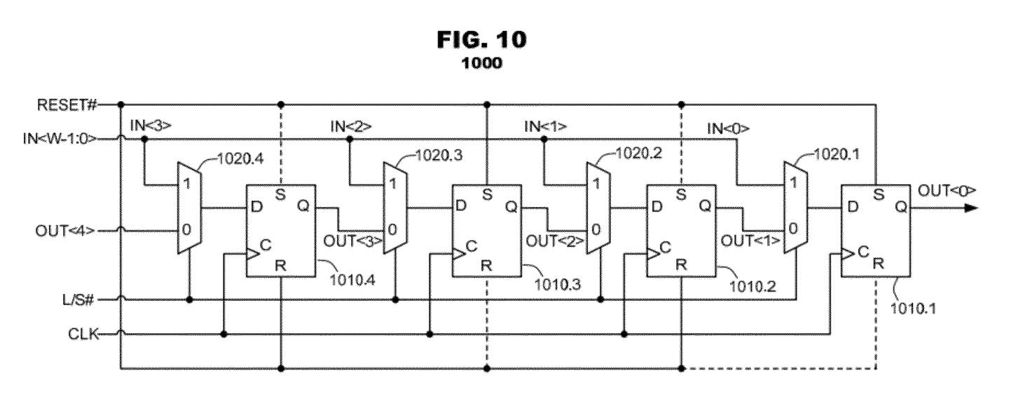

FIG. 10 illustrates a block diagram of an exemplary shift register 1000 according to an embodiment of the present invention. The shift register 1000 may include a plurality of flip-flops 1010.1-1010.W, and a plurality of multiplexers 1020.1-1020.(W−1). In implementation, the register may have a number W of flip-flops and W−1 multiplexers corresponding to a bit width W of an ADC output provided in a battery monitor. Larger registers may be employed to provide bit positions sufficient to carry error flags or other administrative data in addition to the ADC data.

As illustrated, each multiplexer 1020.1-1020.(W−1) may have a pair of inputs. A first input receives data from an associated bit position in <i> of a multi-bit input data word in <W−1:0>, which may be generated from the ADC. A second input receives data from an output of a preceding flip-flop. Each multiplexer 1020.1-1020.(W−1) may be controlled by a single bit control signal L/S#. When the control signal may be high, it may cause the MUX to accept data from the input data word in <i>. When the control signal may be low, it may cause the MUX to accept data from the output of the preceding flip-flop. Each multiplexer 1020.1-1020.(W−1) may output selected data to a succeeding flip-flop 1010.1-1010.W. Each flip-flop 1010.1-1010.W may input data present on its D terminal at the rising edge of a clock CLK signal and hold the input data on its output terminal Q until a new occurrence of the CLK signal edge. Each flip-flop 1010.1-1010.W may be coupled to a RESET control signal.

To generate an alternating bit pattern on reset (e.g., 101010 . . . or 010101 . . . ), the flip-flops may be configured so that flip-flops in odd bit positions (ex., 1010.1, 1010.3, etc.) may be coupled to the RESET signal at their set terminals S. When the RESET signal may be asserted, these flip-flops load a digital value of 1 into the flip-flop. Flip-flops in even bit positions (ex., 1010.2, 1010.4, etc.) may be coupled to the RESET signal at their reset terminals R. When the RESET signal may be asserted, these flip-flops may load a digital value of 0 into the flip-flop. Alternatively, flip-flops at odd bit positions may be coupled to RESET at their reset terminals R and even bit positions may be coupled to RESET at their set terminals S.

Several embodiments of the present invention are specifically illustrated and described herein. However, it will be appreciated that modifications and variations of the present invention are covered by the above teachings and within the purview of the appended claims without departing from the spirit and intended scope of the invention.

I claim:

1. A method for detecting a malfunctioning shift register within a register system, comprising:
loading a predetermined test pattern into shift register(s) of the register system;
reading the stored data pattern out of the register system by a plurality of shift operations,
comparing the read-out data to a locally-generated copy of the predetermined test pattern if the read-out data pattern does not match the locally-generated test pattern, identifying an error.

2. The method of claim 1, wherein the predetermined test pattern is an alternating pattern of ones and zeros.

3. The method of claim 1, wherein:
the shifter register(s) include a plurality of high-reset storage cells and low-reset storage cells, and
the loading comprises resetting the shift register(s).

4. The method of claim 1, wherein the loading further comprises writing the predetermined test pattern in parallel to each shift register.

5. The method of claim 1, wherein:
the method is operable in a system that includes a plurality of battery monitor chips, each chip including a plurality of shift registers for storage of digital data representing measured battery voltages; and
the comparing comprises, if the read-out data does not match the copy of the predetermined test pattern:
parsing the read-out data into data words,
identifying a data word that caused the error, and
correlating the data word to an integrated circuit containing the shift register in which the error is present.

6. A battery monitor, comprising:
a first multiplexer having inputs for connection to a predetermined number of battery cells;
an analog to digital converter (ADC) having an input coupled to an output of the multiplexer; and
a register file having a plurality of shift registers, one shift register for each of a plurality of channels supported by the battery monitor, each shift register including a plurality of high-reset storage cells and low-reset storage cells therein.

7. The battery monitor of claim 6, further comprising a controller adapted to reset the shift registers.

8. The battery monitor of claim 7, wherein the controller further is adapted to following the reset, read stored data out of the shift registers by a plurality of shift operations,
compare the read-out data to a locally generated test pattern that matches distribution of the high-reset storage cells and low-reset storage cells, and
if the read-out data does not match the locally generated test pattern, identify an error.

9. A battery monitor, comprising:
a first multiplexer having inputs for connection to a predetermined number of battery cells;
an analog to digital converter (ADC) having an input coupled to an output of the multiplexer;
a register file having a plurality of shift registers, one shift register for each of a plurality of channels supported by the battery monitor; and
a controller adapted to write a predetermined test pattern into the shift registers.

10. The battery monitor of claim 9, wherein the controller further is adapted to following the write, read stored data out of the shift registers by a plurality of shift operations,
compare the read-out data to the written test pattern, and
if the read-out data does not match the written test pattern, identify an error.

11. A battery monitor system, comprising:
a plurality of battery monitors, each battery monitor comprising having
inputs for connection to a stack of battery cells:
an analog to digital converter provided in communication with the inputs, and
a register file having a plurality of shift registers, each shift register including a plurality of high-reset storage cells and low-reset storage cells therein;
serial communication links provided among the battery monitors to form a daisy chain communication link; and
a processor provided on one end of the daisy chain communication link.

12. The system of claim 11, wherein each battery monitor further comprises a controller adapted to reset the shift registers within the respective battery monitor.

13. The system of claim 11, wherein the processor is adapted to:
following the reset, read stored data out of the register file by a plurality of shift operations via the communication link,
compare the read-out data to a locally generated test pattern that matches distribution of the high-reset storage cells and low-reset storage cells of the register files, and
if the read-out data does not match the locally generated test pattern, identify an error.

14. A battery monitor system, comprising:
a plurality of battery monitors, each battery monitor comprising having
inputs for connection to a stack of battery cells:
an analog to digital converter provided in communication with the inputs,
a register file having a plurality of shift registers, and
a controller adapted to write a predetermined test pattern into the shift registers.
serial communication links provided among the battery monitors to form a daisy chain communication link; and
a processor provided on one end of the daisy chain communication link.

15. The system of claim 14, wherein the processor is adapted to:
following the controller write, read stored data out of the register file by a plurality of shift operations via the communication link,
compare the read-out data to the written test pattern of the register files, and
if the read-out data does not match the written test pattern, identify an error.

16. The system of claim 14, wherein the controller further is adapted to receive a test pattern type, associate the test type with a predetermined test pattern, and write the predetermined test pattern into the shift registers by a plurality of parallel shift operations.

17. The system of 16, wherein the processor further is adapted to:
communicate a test pattern type the controller,
following the controller write, read stored data out of the shift registers by a plurality of shift operations,
compare the read-out data to the written test pattern, and if the read-out data does not match the written test pattern, identify an error.

18. A battery monitor shift register for storing an N-bit data word, comprising:
a plurality of flip-flops, one flip-flop for storing each bit of the N-bit data word, each flip-flop including a high-reset state and a low-reset state, each succeeding flip-flop communicating with a proceeding flip-flop;
a plurality of multiplexers situated in communication between each of the plurality of flip-flops, each multiplexer adapted to communicate an associated bit of the N-bit word to a succeeding flip-flop.

19. The battery monitor shift register of claim 18, wherein each of the plurality of flip-flops associated with an odd numbered bit of the N-bit data word is adapted to be reset to a high-reset state.

20. The battery monitor shift register of claim 19, wherein each of the plurality of flip-flops associated with an even numbered bit of the N-bit data word is adapted to be reset to a low-reset state.

21. The battery monitor shift register of claim 18, wherein each of the plurality of flip-flops associated with an even numbered bit of the N-bit data word is adapted to be reset to a high-reset state.

22. The battery monitor shift register of claim 21, wherein each of the plurality of flip-flops associated with an odd numbered bit of the N-bit data word is adapted to be reset to a low-reset state.

23. The battery monitor shift register of claim 18, further comprising a control signal adapted to facilitate data shifting operations wherein:
when the control signal is high, each of the plurality of flip-flops may receive and store an associated bit of the N-bit data word, and
when the control signal is low, each of the plurality of flip-flops may receive and store a data bit from a preceding flip-flop.
